(19) United States
(12) Patent Application Publication
(10) Pub. No.: US 2008/0131194 A1
(43) Pub. Date: Jun. 5, 2008

(54) Disaster-safe apparatus for binding and maintaining documents

(76) Inventor: Patrick Williams, De Ridder, LA (US)

Correspondence Address: Ted M. Anthony, P. O. Box 3408, Lafayette, LA, 70502, US

(21) Appl. No.: 11/982,750

(22) Filed: Nov. 5, 2007

Related U.S. Application Data
(60) Provisional application No. 60/864,525, filed on Nov. 6, 2006.

(51) Int. Cl. B42F 13/00

(52) U.S. Cl. 402/73

(57) ABSTRACT

The disaster-safe binding apparatus of the present invention comprises a rigid, fire, and water-resistant binder beneficially sized to accommodate documents, plats, and/or other materials to be maintained therein. The binder comprises a rigid book frame constructed of stainless steel. All or substantially all of the outer surfaces of the rigid frame are covered with non-flammable and self-extinguishing material. A gasket assembly extends around the opening of the binder apparatus. When the binder apparatus is closed, the gasket assembly acts to form a water-resistant seal to protect the internal contents of the binder from moisture, water, and/or other harmful external elements.

### CROSS REFERENCES TO RELATED APPLICATIONS

This application claims the Benefit of U.S. Provisional Patent application Ser. No. 60/864,525, filed Nov. 6, 2006.

### STATEMENTS AS TO RIGHTS TO INVENTIONS MADE UNDER FEDERALLY SPONSORED RESEARCH AND DEVELOPMENT

None

### BACKGROUND OF THE INVENTION

1. Field of the Invention

The present invention pertains to an apparatus for binding, storing and displaying documents including, without limitation, public documents recorded in a county clerk's office or other similar repository. More particularly, the present invention pertains to a disaster-proof apparatus for binding and maintaining documents, while protecting the contents of such apparatus from smoke, wind, water, fire or other damage.

2. Brief Description of the Prior Art

Documents, plats, and materials of various types are typically maintained in document repositories or archives in many different locations around the world. By way of illustration, but not limitation, one common situation where such original documents are typically maintained is in county recorder or county clerk offices. Such offices function to preserve and provide for the public a true and reliable, readily accessible and permanent account of real property and other official records and vital human events, both historic and current. Documents recorded in such offices become part of the public records in the particular localities served by such offices. Many different types of documents and/or other materials can also be recorded to provide the public with notice of chain of title or other interest in real property.

Although such documents are often imaged and saved, either digitally or on film, it is beneficial to maintain original versions of the documents. In some locations, clerk and/or recorder offices are required to maintain original documents under applicable law or other governmental rule or regulation. Thus, at any given time, county clerk and/or recorder offices can house a large number of original documents.

Regardless of the particular reasons for maintaining original documents, in virtually all cases the owner, custodian or possessor of such documents (including, without limitation, county clerks and other similar officials) must be concerned with protecting such documents from damage, while still permitting access to such documents. While stored documents can be subject to gradual deterioration over time, such documents can also suffer damage from relatively sudden catastrophic events. Such catastrophic events include, but are not necessarily limited to, fires, floods, wind-storms and/or natural disasters.

In most cases, county clerks and other similar officials store and maintain documents in large book-like binders; such binders provide a basic containment structure for the documents, while allowing for convenient access to such documents. Unfortunately, existing binding devices do not provide necessary protection for documents contained therein, and do not protect documents against the damaging effects of catastrophic events. Thus, it is an object of the present invention to provide a disaster-safe apparatus for maintaining historical and original documents. Said apparatus will beneficially protect documents contained therein from damage from outside elements or forces, while still permitting efficient storage of such documents and, when desired, easy access to said documents.

### SUMMARY OF THE PRESENT INVENTION

The disaster-safe binding apparatus of the present invention comprises a rigid, fire and water-resistant binder beneficially sized to accommodate documents, plats and/or other materials to be maintained therein. Although the binding apparatus of the present invention can be constructed of any number of different materials, in the preferred embodiment said binder comprises a rigid frame constructed of stainless steel.

Said rigid frame can be constructed in any number of different configurations. However, in the preferred embodiment, said rigid frame comprises substantially planar front and back cover assemblies. Both said front and back cover assemblies are connected to a spine assembly using at least one hinge assembly. In combination, said front and back cover assemblies and spine assembly define a book block; said book block is beneficially sized to accommodate the documents or other materials to be contained within said binding apparatus.

In the preferred embodiment, said rigid frame is constructed of stainless steel because stainless steel will not rust, emit harmful acids, or stain or discolor documents contained within said frame. By way of illustration, but not limitation, it is to be observed that the preferred embodiment of the rigid frame of the present invention may be beneficially constructed of 22 gauge, 316 stainless steel. Further, a stainless steel apron wraps substantially around the entire circumference of said book block except for said spine assembly, and an air gap is provided between said book block and apron. In the preferred embodiment, said air gap is approximately ¼″ wide.

All or substantially all of the outer surfaces of said rigid book block frame are covered with non-flammable and self-extinguishing material. In the preferred embodiment, said material meets applicable professional specifications such as, for example, NFPA Code Class 1. Such material can be treated to meet NFPA 701, NFPA 260 and Cal 117-F. Said outer material can be aesthetically pleasing and, if desired, designed to resemble the outer surfaces of conventional binder assemblies.

In the preferred embodiment, a gasket assembly surrounds said apron and spine assembly. When the binder assembly is closed, said gasket assembly acts to form a water-resistant seal to protect the internal contents of the binder from moisture and/or water. Specifically, said sealing mechanism provides protection against potential water damage from multiple sources including, without limitation, leaking pipes, rain or flood waters, and/or fire fighting efforts.

Said gasket assembly also promotes an internal micro-climate within said rigid frame. When said binder is closed and sealed, said micro-climate environment (including relative humidity and atmospheric pollutants) within said binding apparatus can be beneficially regulated. Said micro-climate can be regulated using existing products (for example MicroChamber Barrier Boards and Buffered Silica Gel) which are well known by those having skill in the art. Controlling the interior environment within said binding apparatus protects the contents situated therein, and inhibits the growth of mold during and after disasters. This can be especially beneficial when HVAC systems are not functioning for prolonged periods such as, for example, during power outages caused by natural disasters.

In the preferred embodiment, a foam member is disposed along the inner surface of said substantially planar front cover. Said foam member provides physical support to the contents of said binding apparatus when said apparatus is closed. Moreover, said foam member can conveniently and beneficially provide a support media for silica gel or other additives that can help control the micro-climate within said binder. Said foam member also permits easy grasping of contents within said binding apparatus.

The binding apparatus of the present invention further comprises a stainless steel latch to secure said front cover when the binding assembly is closed. The latch aids in maintaining a water-resistant seal, supporting the foam member and preventing damage to the contents within said binder in the event of inadvertent collision or accidental drop of said binder.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed.

FIG. 1 depicts a side perspective view of the binding apparatus of the present invention along the spine assembly of said binding apparatus.

FIG. 2 depicts, an alternative side perspective view of the binding apparatus of the present invention along the front opening face of said binding apparatus.

FIG. 3 depicts a top view of the cover of the binding apparatus of the present invention.

FIG. 4 depicts a side view of the bottom edge of the binding apparatus of the present invention.

FIG. 5 depicts a side view of the front face and latching mechanism of the binding apparatus of the present invention.

FIG. 6 depicts a side view of the spine assembly of the binding apparatus of the present invention.

FIG. 7 depicts a side view of the top edge of the binding apparatus of the present invention.

FIG. 8 depicts a perspective view of the binding apparatus of the present invention in a partially open position.

FIG. 9 depicts a cross sectional view of the binding apparatus of the present invention along line 9-9 of FIG. 3.

FIG. 10 depicts a cross sectional view of the binding apparatus of the present along line 10-10 of FIG. 4.

FIG. 11 depicts an isolated view of the portion of the binding apparatus of the present invention highlighted in FIG. 10.

FIG. 12A depicts an exploded view of a portion of the binding apparatus of the present invention.

FIG. 12B depicts an exploded view of a portion of the binding apparatus of the present invention.

### DETAILED DESCRIPTION OF A PREFERRED EMBODIMENT OF THE INVENTION

The disaster-safe binding apparatus of the present invention comprises a rigid, fire and water-resistant binder beneficially sized to accommodate documents, plats and/or other materials to be maintained therein. In the preferred embodiment, said binder comprises a rigid frame having substantially planar front and back cover assemblies. Said front and back cover assemblies are connected to a spine assembly using at least one hinge assembly. Said front and back cover assemblies and spine assembly cooperate to form a book-like structure defining a book block; said book block is beneficially sized to accommodate documents, plats or other materials contained within said binding apparatus.

It is to be observed that the disaster safe binding apparatus of the present invention can be utilized in connection with any number of different uses or applications. However, said apparatus is particularly beneficial as a binder for storing, maintaining and displaying documents recorded with a county clerk or other similar official. The binding apparatus of the present invention permits efficient and effective storage of documents. When desired, said binding apparatus further permits convenient access to, and display of, such documents. Significantly, the disaster-safe binding apparatus of the present invention also protects documents and/or other materials contained therein from potential damage caused by outside elements.

Referring to the drawings, FIG. 1 depicts a side perspective view of a preferred embodiment of binding apparatus 100 of the present invention. Binding apparatus 100 comprises substantially rectangular and substantially planar front cover assembly 10, substantially rectangular and substantially planar back cover assembly 20 (partially obscured from view in FIG. 1), and spine assembly 30. Front cover assembly 10 is connected to spine assembly 30 by elongate hinge assembly 31; in the preferred embodiment, hinge assembly 31 extends substantially along the entire length of front cover assembly 10. Bottom apron member 40 is disposed along the inner surface of substantially planar front cover assembly 10. Although not fully visible in FIG. 1, apron members, such as bottom apron member 40, extend along all sides of binding assembly 100, except for the side occupied by spine assembly 30. Front cover assembly 10, back cover assembly 20, spine assembly 30 (as well as all connecting hinge assemblies, such as hinge assembly 31) and apron members (including bottom apron member 40) collectively cooperate to form a book-like structure defining a book block. It is to be observed that apron member 40 is depicted with a protective covering on its outer surface, as will be discussed in detail below.

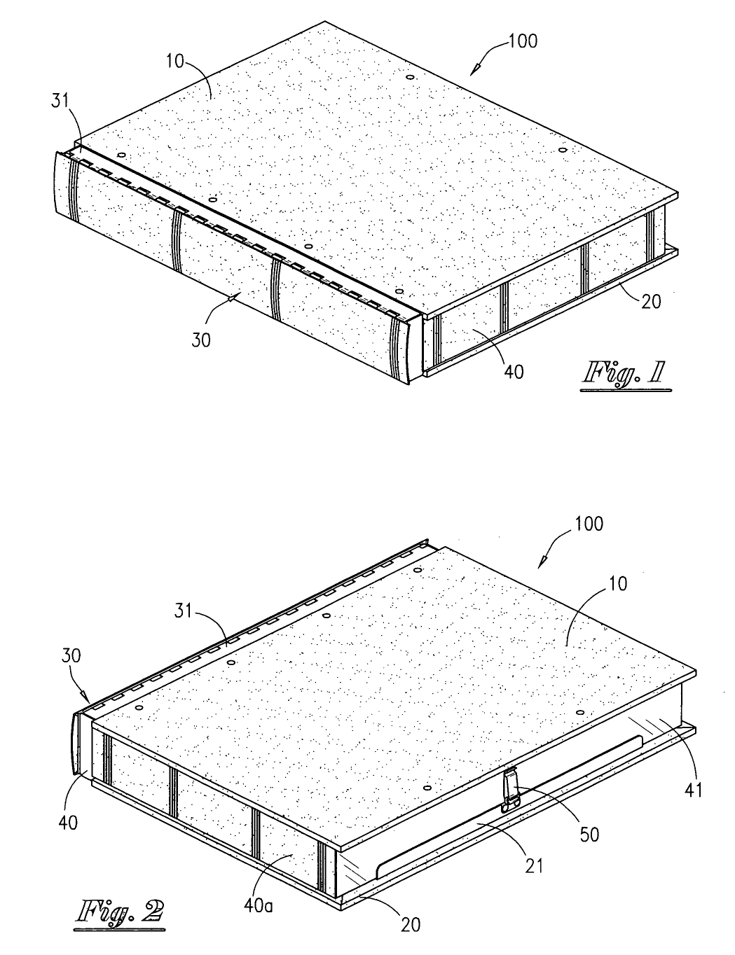

FIG. 2 depicts an alternative side perspective view of binding apparatus 100 of the present invention from the opposite direction as the view that is depicted in FIG. 1. Binding apparatus 100 comprises substantially rectangular and substantially planar front cover assembly 10, substantially rectangular and substantially planar back cover assembly 20 (partially obscured from view-in FIG. 2), and spine assembly 30. Front cover assembly 10 is connected to spine assembly 30 using elongate hinge assembly 31; in the preferred embodiment, hinge assembly 31 extends substantially along the entire length of front cover assembly 10. Bottom apron member 40 is disposed along the lower surface of front cover assembly 10, while side apron member 41 is oriented substantially parallel to spine assembly 30.

Still referring to FIG. 2, flap member 21 extends from the inner surface of substantially planar back cover assembly 20. In the preferred embodiment, flap member 21 forms a planar surface that is oriented substantially parallel to side apron member 41 (and spine assembly 30) when binding apparatus 100 is oriented in a closed position. Latch assembly 50 is disposed on side apron member 41, and can engage with flap member 21 to selectively secure binding apparatus 100 in a closed position.

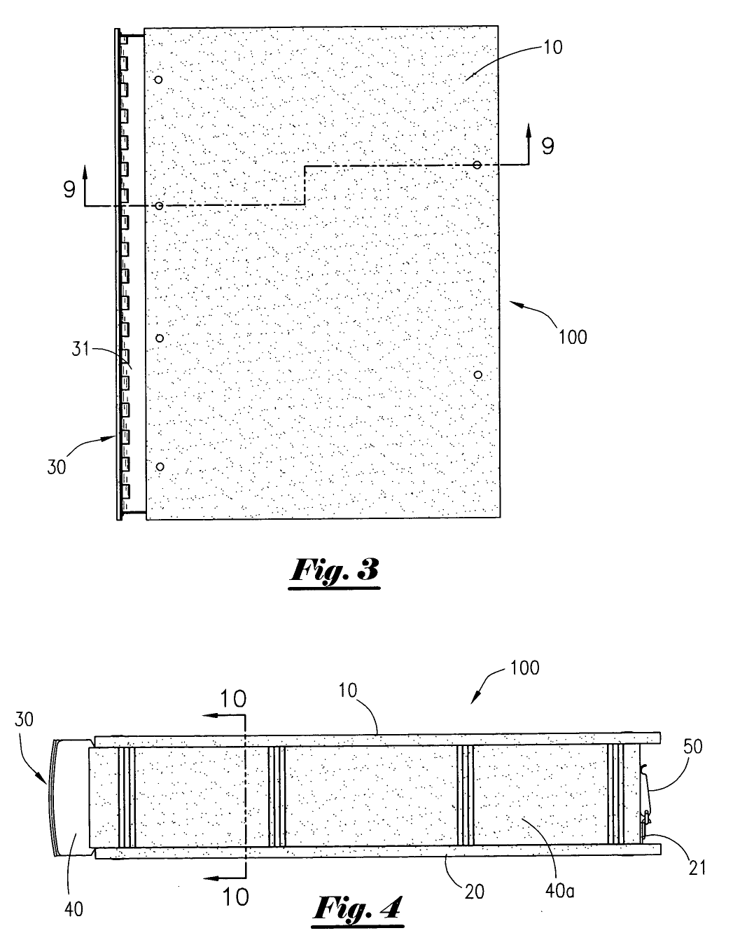

FIG. 3 depicts a top view of binding apparatus 100 of the present invention. Substantially rectangular and substantially planar front cover assembly 10 is connected to spine assembly 30 using elongate hinge assembly 31.

FIG. 4 depicts a side view of binding apparatus 100 of the present invention along its bottom edge. Front cover assembly 10, back cover assembly 20, spine assembly 30 and apron members (including bottom apron member 40) cooperate to form a book-like structure. Flap member 21 extends upward from the inner surface of substantially planar back cover assembly 20, while latch assembly 50 is disposed on side apron member 41 (not visible in FIG. 4).

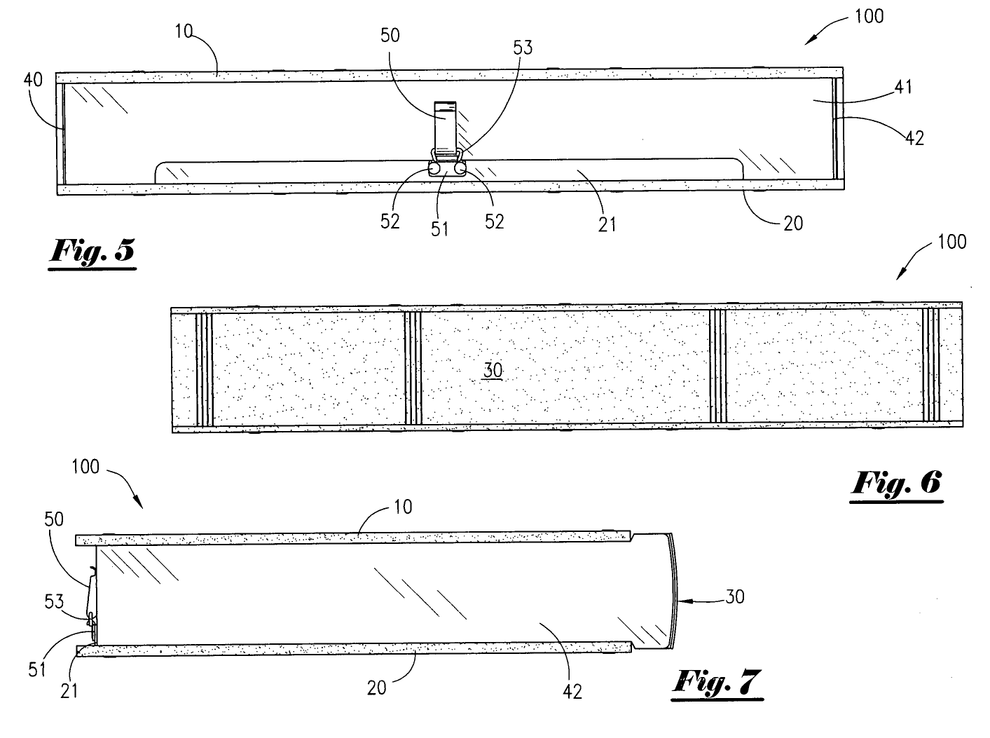

FIG. 5 depicts a side view of the front face and latch assembly 50 of binding apparatus 100 of the present invention. In the preferred embodiment, front cover assembly 10 and back cover assembly 20 are oriented parallel to one another. Side apron member 41, bottom apron member 40 and top apron member 42 all extend from the inner surface of front cover assembly 10. Bottom apron member 40 and top apron member 42 are oriented parallel to one another, while side apron member 41 is oriented perpendicular to said top and bottom apron members. Flap member 21 extends upward from the inner surface of substantially planar back cover assembly 20, while latch assembly 50 having loop 53 is disposed on apron section 41. Latch hook 51 is disposed on flap member 21 and can selectively engage with loop 53 to secure binding apparatus in a closed position. In the preferred embodiment, said latch hook 51 is secured to flap member 21 using rivets 52.

FIG. 6 depicts a side view of the outer surface spine assembly 30 of binding apparatus 100 of the present invention. In the preferred embodiment, spine assembly 30 provides a convenient surface for display of characters or indicia. By way of illustration, but not limitation, volume numbers, dates and/or other useful information can be easily and efficiently displayed on the surface of spine assembly 30.

FIG. 7 depicts a side view of binding apparatus 100 of the present invention along top edge of binding apparatus 100. Front cover assembly 10, back cover assembly 20, spine assembly 30 and apron members (including top apron member 42) cooperate to form a book-like binding apparatus. Flap member 21 extends upward from the inner surface of substantially planar back cover assembly 20, while latch assembly 50, having loop 53 and latch hook 51, is disposed on side apron member 41 (not visible in FIG. 4).

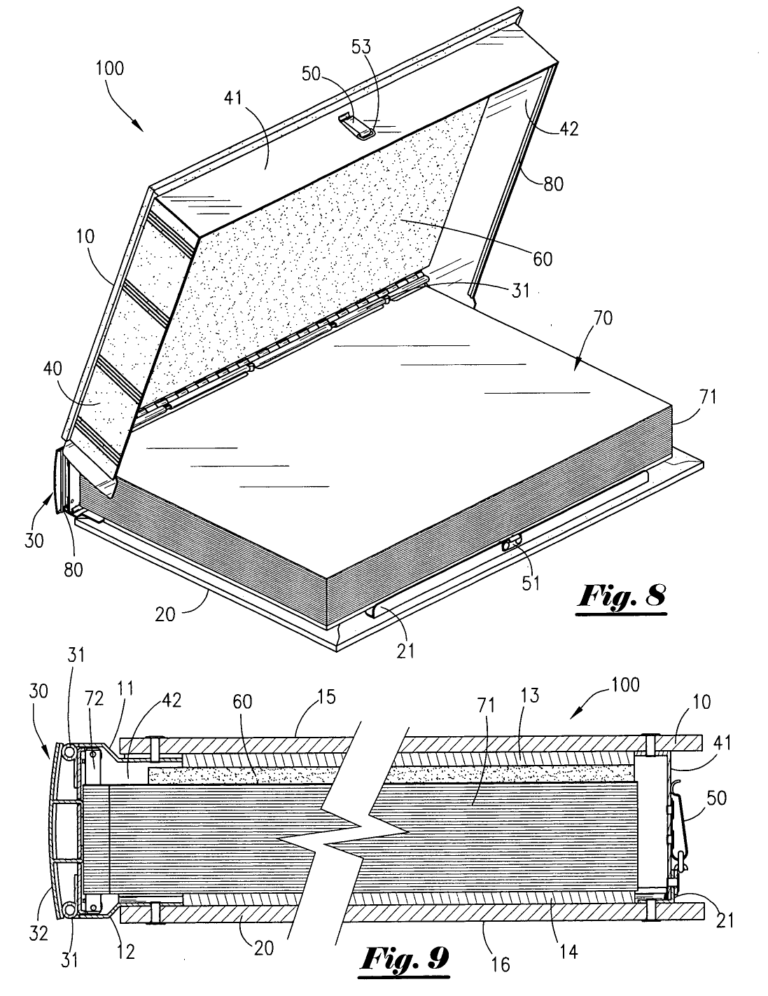

FIG. 8 depicts a perspective view of binding apparatus 100 of the present invention in a partially open position. Binding apparatus 100 comprises substantially rectangular and substantially planar front cover assembly 10, substantially rectangular and substantially planar back cover assembly 20, and spine assembly 30. Front cover assembly 10 is connected to spine assembly 30 by elongate hinge assembly 31. In the preferred embodiment, hinge assembly 31 extends substantially along the entire length of front cover assembly 10. Side apron member 41, bottom apron member 40 and top apron member 42 all extend from the inner surface of front cover assembly 10. Bottom apron member 40 is oriented parallel to top apron member 42, while side apron member 41 is oriented perpendicular to said top and bottom apron members.

Still referring to FIG. 8, flap member 21 extends from the inner surface of substantially planar back cover assembly 20. In the preferred embodiment, flap member 21 forms a planar surface that is oriented perpendicular to back cover assembly 20. Latch assembly 50 having loop 53 is disposed on side apron member 41, and can engage with latch hook 51 on flap member 21 to selectively secure binding apparatus 100 in a closed position.

Still referring to FIG. 8, foam insert 60 is disposed along the inner surface of said substantially planar front cover assembly 10, in the area formed between spine assembly 30 and apron members 40, 41 and 42. Said foam insert 60 provides physical support to the contents of said binding apparatus 100 when said apparatus is closed. Moreover, said foam insert 60 can conveniently and beneficially provide a support media for silica gel or other additives that can help control the micro-climate within said binding apparatus 100 when it is in a closed position. Said foam insert 60 also permits easy grasping of contents stored or maintained within said binding apparatus 100.

Still referring to FIG. 8, contents 70 are mounted within binding apparatus 100 of the present invention. In most instances, contents 70 comprise a plurality of separate mounting pages that can support original instruments, plats and/or other documents maintained within binding apparatus 100. Alternatively, instead of mounting pages, transparent plastic pockets or other similar devices can be secured within binding apparatus 100.

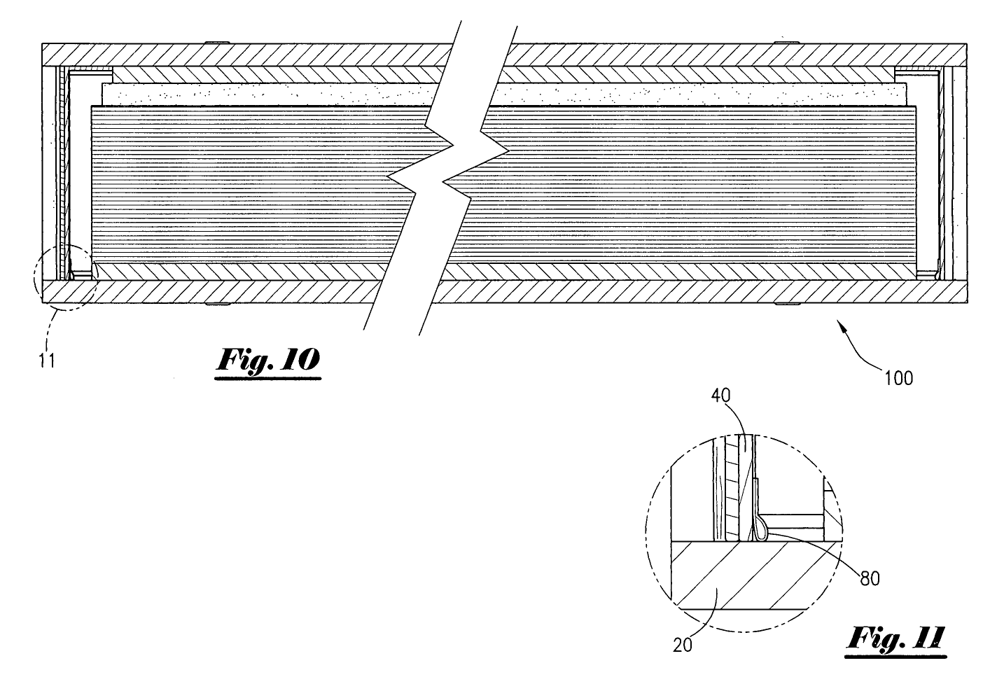

FIG. 9 depicts a cross sectional view of binding apparatus 100 of the present invention along line 9-9 of FIG. 3. In the preferred embodiment, front cover assembly 10 comprises front cover frame member 11, which is pivotally attached to spine assembly 30 using hinge assembly 31. Similarly, back assembly cover 20 comprises back cover frame member 12, which is also pivotally attached to spine assembly 30 using hinge assembly 31. In the preferred embodiment, apron member 41 is attached to front cover frame member 11. In the preferred embodiment, it is to be observed that hinge members 31 cooperate to permit front cover assembly 10, spine assembly 30 and back cover assembly 20 to lay substantially flat when said binding apparatus 100 is fully opened.

In the preferred embodiment, all rigid frame components including, without limitation, front cover frame member 11, back cover frame member 12, spine assembly 30, hinge assemblies 31, flap member 21 and apron members 40, 41 and 42 are constructed of stainless steel. In the preferred embodiment, stainless steel is used for said frame components because it will not rust, emit harmful acids, or stain or discolor documents contained within binding apparatus 100. By way of illustration, but not limitation, it is to be observed that the preferred embodiment of the present invention, rigid frame of the present invention may be beneficially constructed of 22 gauge, 316 stainless steel.

Still referring to FIG. 9, spacer board 13 is affixed to the inner surface of front cover frame member 11, while spacer board 14 is affixed to the inner surface of back cover frame member 12. In the preferred embodiment of the present invention, front outer shell member 15 is attached to the outer surfaces of front cover frame member 11, while back outer shell member 16 is affixed to the outer surface of back cover frame member 12. Similarly, outer covering 32 is disposed along the outer surface of spine assembly 30. In the preferred embodiment, said front outer shell member 15, back outer shell member 16 and outer covering 32 comprise non-flammable and self-extinguishing material. In the preferred embodiment, said non-flammable and self-extinguishing material meets applicable professional specifications such as, for example, NFPA Code Class 1, and is treated to meet NFPA 701, NFPA 260 and Cal 117-F. Said cover boards can be aesthetically pleasing and, if desired, designed to resemble the outer surfaces of conventional binder assemblies. In the preferred embodiment, such non-flamable and self-extinguishing material is also disposed along the outer surfaces of apron members 40 and 42.

Still referring to FIG. 9, mounting pages 71 are secured in place within binding apparatus using mounting bracket 72 which passes through apertures in mounting pages 71. Foam insert 60 is disposed along the inner surface of spacer board 13, which is in turn affixed to the inner surface of front cover frame member 11. Stainless steel latch assembly 50 aids in maintaining a water-resistant seal, supporting foam member 60 and preventing damage to mounting pages 71 and any attached documents or other contents in the event of inadvertent collision or accidental dropping of binding apparatus 100.

Referring back to FIG. 8 in the preferred embodiment, flexible gasket assembly 80 extends around said apron members and spine assembly. When binding apparatus 100 is closed, said gasket assembly 80 acts to form a water-resistant seal to protect the internal contents 71 of the binding assembly from moisture and water. Specifically, said sealing mechanism provides protection against potential water damage from multiple sources including, without limitation, leaking pipes, rain, flood waters and/or fire fighting efforts.

The sealing mechanism created by actuation of gasket 80 also promotes an internal micro-climate within said rigid frame of binding apparatus 100. When said binding apparatus is closed and sealed, said micro-climate environment (including relative humidity and atmospheric pollutants) within said binding apparatus can be beneficially regulated. Said micro-climate can be regulated using existing products (for example MicroChamber Barrier Boards and Buffered Silica Gel) well known by those having skill in the art. Controlling the interior environment within said binding apparatus 100 protects the contents situated therein, and inhibits the growth of mold during and after disasters. This can be especially beneficial when HVAC systems are not functioning for prolonged periods such as, for example, during power outages caused by natural disasters.

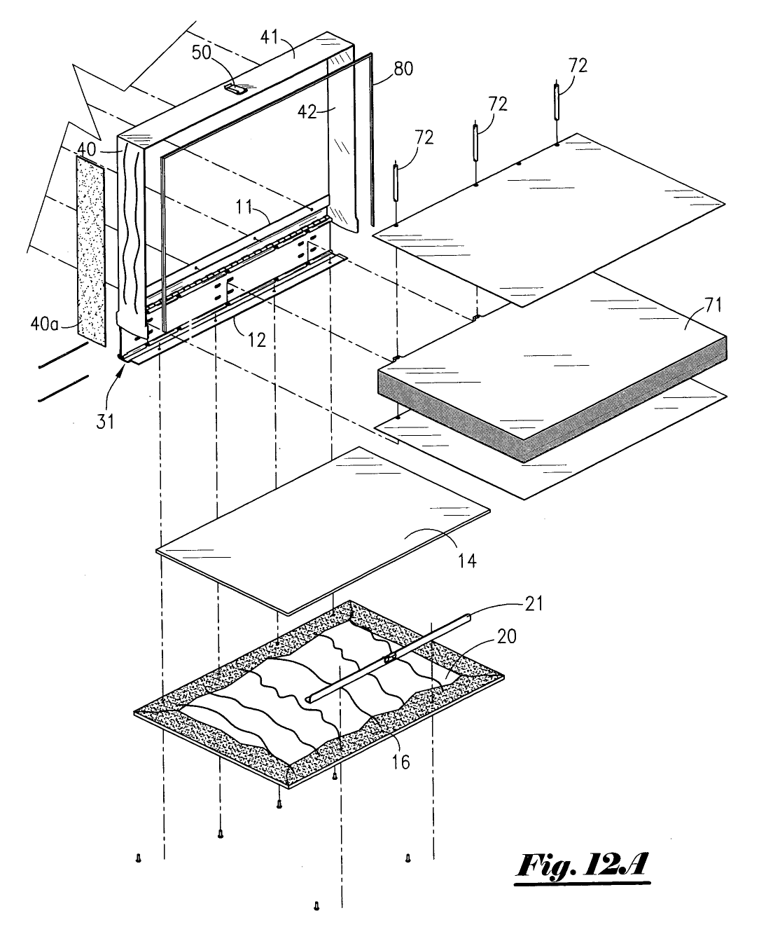

FIG. 10 depicts a cross sectional view of binding apparatus 100 of the present invention along line 10-10 of FIG. 4. FIG. 11 depicts an isolated view of the portion of the binding apparatus of the present invention highlighted in FIG. 10. Specifically, FIG. 11 depicts actuation of gasket member 80 that forms the seal within binding apparatus 100 as discussed above.

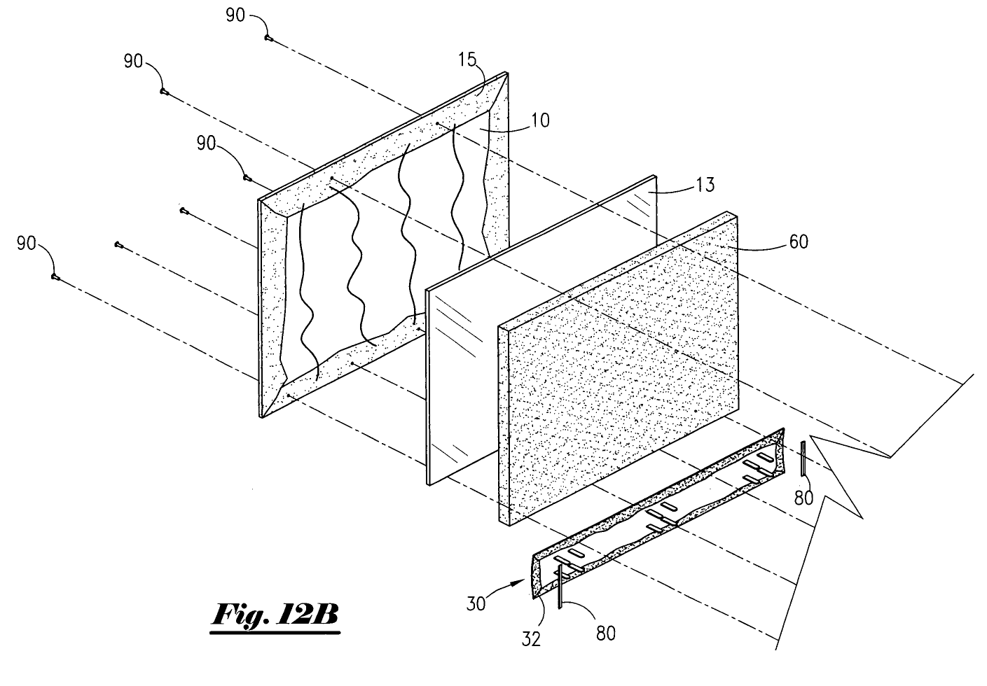

FIG. 12A depicts an exploded view of a portion of the binding apparatus 100 of the present invention, while FIG. 12B depicts an exploded view of a portion of the binding apparatus of the present invention. In the preferred embodiment, front cover assembly 10 comprises front cover frame member 11, which is pivotally attached to spine assembly 30 using hinge assembly 31. Similarly, back assembly cover 20 comprises back cover frame member 12, which is also pivotally attached to spine assembly 30 using hinge assembly 31. In the preferred embodiment, apron member 41 is attached to front cover frame member 11.

In the preferred embodiment, all rigid frame components including, without limitation, front cover frame member 11, back cover frame member 12, spine assembly 30, hinge assemblies 31, flap member 21 and apron members 40, 41 and 42 are constructed of stainless steel. In the preferred embodiment, stainless steel is used for said frame components because it will not rust, emit harmful acids, or stain or discolor documents contained within binding apparatus 100.

Spacer board 13 is affixed to the inner surface of front cover frame member 11, while spacer board 14 is affixed to the inner surface of back cover frame member 12. In the preferred embodiment of the present invention, front outer shell member 15 is attached to the outer surfaces of front cover frame member 11, while back outer shell member 16 is affixed to the outer surface of back cover frame member 12. Similarly, outer covering 32 is disposed along the outer surface of spine assembly 30. In the preferred embodiment, said front outer shell member 15, back outer shell member 16 and outer covering 32 comprise non-flammable and self-extinguishing material. In the preferred embodiment, such non-flammable and self-extinguishing material 40a is also disposed along the outer surfaces of apron members 40.

Still referring to FIG. 9, mounting pages 71 are secured in place within binding apparatus 100 using mounting brackets 72 which pass through apertures in mounting pages 71. Although not depicted in FIG. 12 A or 12B, foam insert 60 is disposed along the inner surface of spacer board 13, which is in turn affixed to the inner surface of front cover frame member 11. Stainless steel latch assembly 50 aids in maintaining a water-resistant seal, supporting foam member 60 and preventing damage to mounting pages 71 and any attached documents or other contents in the event of inadvertent collision or accidental dropping of binding apparatus 100.

Flexible gasket assembly 80 extends around said apron members and spine assembly. When binding apparatus 100 is closed, said gasket assembly 80 acts to form a water-resistant seal to protect the internal contents 71 of the binding assembly from moisture and water. Specifically, said sealing mechanism provides protection against potential water damage from multiple sources including, without limitation, leaking pipes, rain, flood waters and/or fire fighting efforts.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

1. (canceled)

2. A disaster-proof binder comprising:
a. a first substantially planar cover member having an upper surface and a lower surface;
b. a second substantially planar cover member having an upper surface and a lower surface;
c. a spine assembly having a first end and a second end;
d. a first hinge assembly connecting said first substantially planar cover member to said spine assembly;
e. a second hinge assembly connecting said second substantially planar cover member to said spine assembly;
f. an apron assembly extending along said lower surface of said first substantially planar cover member from the first end of said spine assembly to the second end of said spine assembly; and
g. means for latching said apron assembly to said second substantially planar cover member.

3. The disaster-proof binder of claim 2, wherein said first cover member, second cover member, spine assembly and apron assembly are stainless steel.

4. The disaster-proof binder of claim 2, further comprising a flame resistant material disposed on the upper surface of said first cover member, the lower surface of said second cover member and said spine assembly.

5. The disaster-proof binder of claim 2, further comprising a first gasket member disposed on the edge of said apron assembly, wherein said first gasket member extends substantially along the entire length of said apron assembly.

6. The disaster-proof binder of claim 5, further comprising a second gasket assembly disposed on said spine assembly near said first and second ends of said spine assembly, wherein said second gasket assembly is oriented perpendicular to the longitudinal axis of said spine assembly.

7. The disaster-proof binder of claim 2, further comprising a foam member disposed on the lower surface of said first substantially planar cover member.

8. The disaster-proof binder of claim 2, further comprising silica gel disposed between said first and second substantially planar cover members.

9. A disaster-proof binder comprising:
a. a first substantially planar cover member having four sides, an upper surface and a lower surface;
b. a second substantially planar cover member having four sides, an upper surface and a lower surface;
c. a spine assembly having a first end and a second end;
d. a first hinge assembly connecting one side of said first substantially planar cover member to said spine assembly;
e. a second hinge assembly connecting one side of said second substantially planar cover member to said spine assembly;
f. an apron assembly extending from said lower surface of said first substantially planar cover member at a right angle, wherein said apron assembly is disposed along the three sides of said first substantially planar cover member not connected to said first hinge assembly; and
g. means for latching said apron assembly to said second substantially planar cover member.

10. The disaster-proof binder of claim 9, wherein said first cover member, second cover member, spine assembly and apron assembly are stainless steel.

11. The disaster-proof binder of claim 9, further comprising a flame resistant material disposed on the upper surface of said first cover member, the lower surface of said second cover member and said spine assembly.

12. The disaster-proof binder of claim 9, further comprising a first gasket member disposed on the edge of said apron assembly, wherein said first gasket member extends substantially along the entire length of said apron assembly.

13. The disaster-proof binder of claim 12, further comprising a second gasket assembly disposed on said spine assembly near said first and second ends of said spine assembly, wherein said second gasket assembly is oriented perpendicular to the longitudinal axis of said spine assembly.

14. The disaster-proof binder of claim 9, further comprising a foam member disposed on the lower surface of said first substantially planar cover member.

15. The disaster-proof binder of claim 9, further comprising silica gel disposed between said first and second substantially planar cover members.
